(19) United States
(12) Patent Application Publication
(10) Pub. No.: US 2008/0307580 A1
(43) Pub. Date: Dec. 18, 2008

(54) Women's anatomical pillows

(76) Inventor: Christy Spitzer, Kirkland, WA (US)

Correspondence Address: Ober, Kaler, Grimes & Shriver;Royal W. Craig, 120 East Baltimore Street, Baltimore, MD, 21202-1643, US

(21) Appl. No.: 12/157,588

(22) Filed: Jun. 11, 2008

Related U.S. Application Data
(60) Provisional application No. 60/934,542, filed on Jun. 14, 2007.

(51) Int. Cl. A61G 7/07

(52) U.S. Cl. 5/636

(57) ABSTRACT

An anatomical pillow set for women and especially those enduring post-op breast surgery recuperation, or any other face-down lying situation such as massage in which compression of the breasts would be painful or uncomfortable. The anatomical pillow generally comprises two separate sections, one with a generally rectangular silhouette and semi-circular recess along the bottom edge, and one with a substantially rectangular silhouette. The two sections are used together. In use, a woman separates the two pillow sections and places the lower section beneath her breasts to support the rib cage, and the top section across her neck with neck cradled in the semi-circular recess. The left and right sides of the top pillow section support the woman's shoulders. Additionally, the woman may use her own pillow to support her head if she so chooses.

### CROSS-REFERENCE TO RELATED APPLICATIONS

The present application derives priority from U.S. provisional application Ser. No. 60/934,542 filed Jun. 14, 2007.

### BACKGROUND OF THE INVENTION

(1) Field of the Invention

The present invention generally relates to pillows and, more particularly, to a specialized pillow set suited for a women's body and having a structure that allows rest with the body lying face downwards, yet which alleviates compression of the breasts, especially after breast surgery or during massage or any other activity that requires lying face down.

(2) Description of Prior Art

A variety of pillows have been designed to aid in therapy, sleep or relaxation. For example, some pillows are shaped to provide support for a person's neck. Other pillows are designed to provide lumbar support, and still others are designed to support a woman's abdominal and stomach areas during pregnancy. Often, such pillows provide support against specific areas of a person's body, while reducing the pressure exerted on other parts of the person's body by the support surface against which the person sits or lies.

For example, U.S. Pat. 4,375,112 issued to Leonhart on Mar. 1, 1983 discloses a pillow for protecting a hairdo. The pillow is made of foam or the like and has a hole in the center in which the hairdo can be received while the person's cheek rests on the area around the hole. The foam is sealed together around the outside periphery of the pillow and the outside periphery of the hole. A pillowcase is provided having a conforming hole in it.

U.S. Pat. No. 6,651,282 issued to Skoug et al. on Nov. 25, 2003 discloses a flexible, crescent shaped pillow to assist mothers to maintain an anatomically correct alignment between mouth and nipple while breast feeding.

U.S. Pat. No. 6,971,128 to McGrath on Dec. 6, 2005 discloses a pillowcase or cover which converts from a first size to accommodate a pillow with a longer length (e.g. king-sized pillow) to a second size to accommodate a pillow with a shorter length (e.g. queen-sized pillow).

United States Patent Application 20050223493 by Setokawa, et al. on Oct. 13, 2005 discloses a pillow 1 which includes a main body 3 having a concave portion 7 in the central part, and a cold insulator 5 mounted in the concave portion 7. This concave portion 7 is open in the central part of the main body side wall 8 on the side where the human nape is to be situated. The cold insulator 5 has a film for inclusion 11, and a gel material 9 which is internally included in the film for inclusion 11 and which includes a cross-linked polymer that is not in a swelled state with a medium.

United States Patent Application 20070089240 by Dazzi on Apr. 26, 2007 discloses a pillow which keeps a woman's breasts separated, raised, and unflattened by the body. The pillow has a donut shape additionally allowing an effective body side support.

United States Patent Application 20060123547 by Ferber, et al. on Jun. 15, 2006 discloses a pillow which includes a neck portion extending along a length of the pillow, and a head portion attached to the neck portion.

United States Patent Application 20010044968 by Schmitter et al. on Nov. 29, 2001 discloses a breast support feeding pillow, which includes a triangular foam pillow with a cotton material covering.

The Intimia™ Breast Pillow is a commercially-available pillow that is worn between the breasts with adjustable straps which crisscross on the back to eliminate wrinkles in the cleavage area.

While the foregoing pillows solve particular problems, none are particularly helpful to women recovering from breast surgery. Post-op breast surgery patients are often advised to sleep on their side and support their breast with a supporting apparatus such as, for example, a pillow. This helps to reduce pain and facilitates healing. However, many women cannot sleep in the prone position and would much prefer to lay face-down. This is near impossible in the post-op context without some form of support for the shoulders and abdomen to take pressure off the breasts. It is likewise difficult in other everyday situations such as sunbathing where compacted sand often feels hard as cement.

Accordingly, it would be desirable to provide a pillow for use by patients recovering from breast surgery, as well as other women seeking comfort during massage or any other face-down resting situation.

### SUMMARY OF THE INVENTION

It is an object to provide an improved pillow set with dual support sections, one for the breasts neck and shoulders, and one for the abdomen, thereby reducing compression of the breasts, for particular use by patients recovering from breast surgery, and as well by other women seeking comfort in a face-down lying situation such as massage.

It is another object to provide a pillow dual support sections as described above capable of accommodating a range of different body sizes and shapes.

In accordance with the foregoing objects, the present invention is a women's pillow set especially helpful during post-op recuperation from breast surgery, but also for use in everyday situations in which a woman wishes to lay face-down such as during massage. The women's pillow generally comprises two separate pillow sections that are used in combination. The top pillow section has a generally rectangular silhouette with a semi-circular recess along the bottom edge, and a rounded cross-section. The bottom pillow section has a generally rectangular silhouette and round cross-section. The women's pillow is preferably constructed with a polyester microfiber twill outer shell fabric, and in a variety of different colors and/or designs. There may be different models with different dimensions to fit a woman of any size.

In use, a woman separates the two pillow sections and places the lower section beneath her breasts to support the rib cage, and the top section across her neck with the breasts cradled in the semi-circular recess. The left and right sides of the top pillow section support the woman's shoulders. Additionally, the woman may use her own pillow to support her head if she so chooses.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a front perspective view of the anatomical pillow set 2 according to the present invention.

FIG. 2 is a front perspective view of the anatomical pillow set 2 of FIG. 1.

### DETAILED DESCRIPTION OF THE PREFERRED EMBODIMENTS

The present invention is an improved pillow set for women that is especially suited for use during post-op recuperation from breast surgery, or in any situations in which a woman wishes to lay face-down.

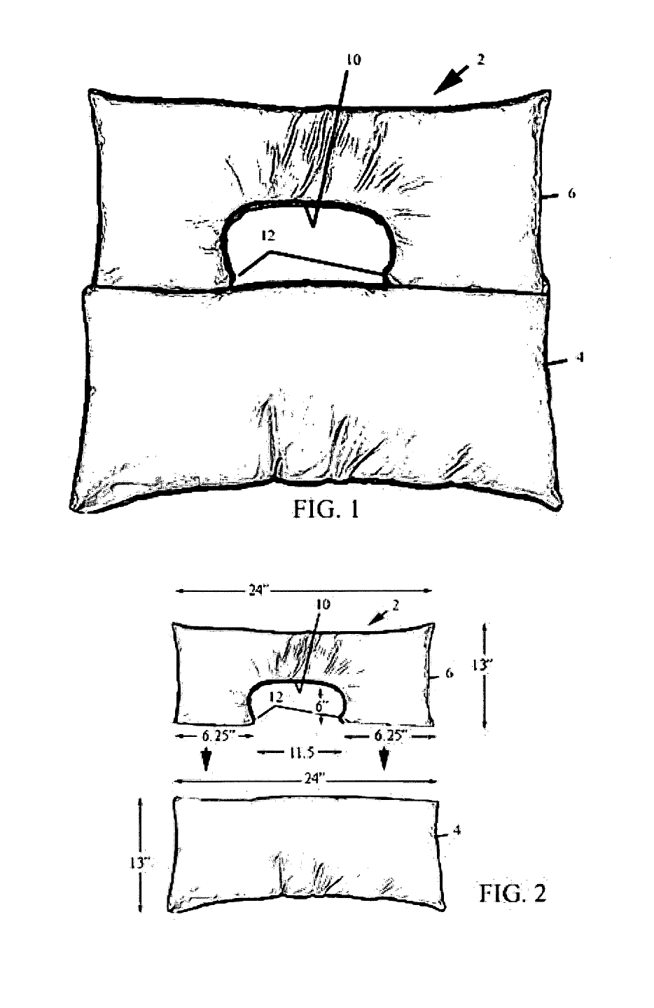

FIG. 1 is a front perspective view of the anatomical pillow set 2 according to the present invention. The women's pillow set 2 generally comprises two separate pillow sections 4, 6 for use in combination. The top pillow section 4 has a generally rectangular silhouette with a semi-circular recess 10 along the bottom edge, and a rounded cross-section. The bottom pillow section 6 has a substantially rectangular silhouette and round cross-section. Both pillow sections 4, 6 may be formed by cutting two fabric blanks to conform to the respective silhouettes, sewing them together and filling.

The outer shell fabric is a polyester microfiber twill such as 100% polyester microfiber by Regency House™. The fill is preferably 100% hypo-allergenic Dacron™ fiber.

The recess 10 of the top pillow section 4 is expansive enough to cradle both breasts comfortably and is preferably bounded by two inwardly protruding “prongs” 12 that abut the rib cage, partially encircling the breasts.

FIG. 2 is a front perspective view of the anatomical pillow 2 of FIG.1 with the two separate pillow sections 4, 6 separated, and illustrating dimensions. The dimensions are very important to the present invention. The top pillow section 4 has a 24″ width, 13″ height, and 11.5″ long by 6″ high recess 10 along the bottom edge formed with rounded corners to yield 6.25″ wide prongs 12 separated by 11.5″. The bottom pillow section 6 has a substantially rectangular silhouette 24″ by 13″ and round cross-section.

The two pillow sections 4, 6 may be provided in a variety of different colors and/or designs, and there may be different models with different dimensions to fit women of various sizes and shapes.

In use, a woman wishing to lie down separates the two pillow sections and places the lower section 4 beneath her breasts to support the rib cage, and the top section 6 across her throat with breasts cradled in the semi-circular recess 10. The top pillow section 4 must be long enough so that the left and right sides extend to under the shoulders to provide support therefore. If desired, a separate (conventional) pillow may also be used to support the head, if the user so chooses.

The improved anatomical pillow 2 serves to support the neck and shoulders (by top section 4) and the abdomen/rib cage (by lower section 6), thereby reducing or eliminating compression of the breasts, and this is particularly helpful for patients recovering from breast surgery as it allows women to lay flat, face-down, without pain. It is also useful in other face-down situations such as sunbathing or massage. Moreover, the separability aspect allows full adjustment to accommodate a range of different body sizes and shapes.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept.

What is claimed is:

1. An anatomical pillow set for women, comprising:
a first pillow section having a generally rectangular silhouette with a semi-circular recess along a bottom edge; and
a second pillow section having a substantially rectangular silhouette;
whereby the two separate pillow sections are used in combination in supporting the neck and shoulders by said first section and the abdomen/rib cage by said second pillow section.

2. The anatomical pillow set according to claim 1, wherein said first pillow section recess defines a top section and opposing prongs.

3. The anatomical pillow set according to claim 2, wherein the top section supports the woman's throat with breasts cradled in the semi-circular recess.

3. The anatomical pillow set according to claim 3, wherein said second pillow section has a rounded cross-section for supporting a woman's abdomen and rib cage.

4. A combination pillow for alleviating compression of a woman's breast while laying face down on a surface, comprising:
a first pillow section having a generally rectangular silhouette with a recess along a bottom edge defining a top section and opposing prongs, the first pillow section being dimensioned so that the top section supports the woman's throat against said surface while breasts are cradled in the semi-circular recess; and
a second pillow section having a generally rectangular silhouette and rounded cross-section for supporting a woman's abdomen and rib cage against said surface.

5. The combination pillow according to claim 4, wherein both of said first and second pillow sections are constructed with a polyester microfiber twill outer shell fabric.

6. The combination pillow according to claim 5, wherein both of said first and second pillow sections are constructed with a hypo-allergenic Dacron™ fiber fill.

7. The combination pillow according to claim 6, wherein the first pillow section has approximately a 24″ width, 13″ height, and is formed with an 11.5″ long by 6″ high recess along its bottom edge.

8. The combination pillow according to claim 7, wherein the first pillow section is formed with approximately 6.25″ wide prongs separated by approximately 11.5″.

9. The combination pillow according to claim 8, wherein the second pillow section is approximately 24″ by 13″.

10. The combination pillow according to claim 9, wherein distal left and right sides of the top pillow section also support the woman's shoulders.
